(19) United States
(12) Patent Application Publication
(10) Pub. No.: US 2001/0022997 A1
(43) Pub. Date: Sep. 20, 2001

(54) Transflective polarizer

(76) Inventors: Masaru Honda, Niihama-shi (JP); Koji Higashi, Niihama-shi (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/776,671

(22) Filed: Feb. 6, 2001

(30) Foreign Application Priority Data
Feb. 7, 2000 (JP) 2000-029158

(51) Int. Cl. G02F 1/1335

(52) U.S. Cl. 428/1.31

(57) ABSTRACT

The present invention provides a transflective polarizer comprising a dichroic polarizer, a reflective polarizer and a transflector, wherein a transmission axis of the dichroic polarizer and a transmission axis of the reflective polarizer are directed to the same direction, which can give a transflective liquid crystal display having higher transmission brilliance than a conventional transflective liquid crystal display while having reflection brilliance corresponding to the conventional transflective liquid crystal display.

### BACKGROUND OF THE INVENTION

1. Field of the Invention

The present invention relates to a transflective polarizer, which is useful for transflective liquid crystal displays.

2. Description of the Related Art

A liquid crystal display has been used in various fields since it can be compact and light. As this liquid crystal display, transflective liquid crystal displays are widely used which can be used as a reflective liquid crystal display under light environment and can be used as a transmissive liquid crystal display by illumination from a built-in back light source under dark environment. This dual function of reflection and transmission leads to the designation, “transflective”.

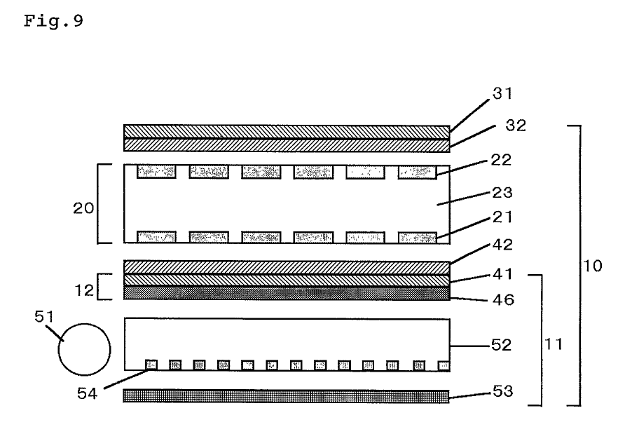

A conventional transflective liquid crystal display (10) will be illustrated using FIG. 9. A liquid cell (20) usually comprises two opposed transparent electrodes, that is, a transparent electrode (21) placed on a back face side and a transparent electrode (22) placed on a front face side, and a liquid crystal layer (23) interposed therebetween (21, 22). Optical elements such as a dichroic polarizer (31), a phase retarder (32) and the like are placed on the front face of the liquid crystal cell (20), and a polarizing light source device (11) is placed on the back face of the liquid crystal cell (20). The liquid crystal cell (20) and the polarizing light source device (11) may be placed via a phase retarder (42) at the back face side of the liquid crystal cell. The polarizing light source device (11) comprises a transflective polarizer (12) composed of a dichroic polarizer (41) and a transflector (46), at a position facing the liquid crystal cell (20), and a light transmitting plate (52) placed on the back face thereof, and a light source (51) placed at the edge or on the back face of the light transmitting plate, and a reflector (53) placed on the back face of the light transmitting plate.

As the transflective polarizer (12), laminated films comprising a transparent or translucent resin film and a polarizing layer wherein a light diffusive substance is dispersed in the translucent resin film (for example, JP-A No. 55-46707), and those in which apearl pigment is dispersed uniformly in a transparent resin film and reflection on the surface of the pearl pigment is utilized (for example, JP-A No. 55-84975) and the like are used.

### SUMMARY OF THE INVENTION

The present invention provides a transflective polarizer, which can give a transflective liquid crystal display having higher transmission brilliance than the conventional technology while having reflection brilliance corresponding to the conventional technology.

First, the present invention provides a transflective polarizer comprising a dichroic polarizer, a reflective polarizer and a transflector, wherein a transmission axis of the dichroic polarizer and a transmission axis of the reflective polarizer are directed to the same direction.

Examples of the dichroic polarizer include an iodine-based polarizing film and a dye-based polarizing film. A light diffusive layer may also be laminated on at least one surface of the dichroic polarizer.

It is preferable to use a multi-layer laminate comprising two or more polymer films, apolymer film consisting of continuous polymer matrix with droplets dispersed therein which is made from two or more kinds of polymers or a film formed by laminating and integrating a film composed of a cholesteric liquid crystal and a quarter wavelength plate as a reflective polarizer.

It is preferable, in the transflector, that a slow axis or fast axis thereof and the transmission axis are directed to the same direction and/or the in-plane phase retardation value of the transflector is 30 nm or less. It is preferable that the transf lector is a layer obtained by forming a metal film on the surface of a polymer film or a layer obtained by dispersing scaly reflective particles in a pressure-sensitive adhesive. As the scaly reflective particle, a particle obtained by forming a layer composed of ametal oxide on the surface of a mica piece can be preferably used.

Second, the present invention provides a polarizing light source device obtained by laminating a transflective polarizer of the present invention, a light source and a reflector in this order, or a polarizing light source device obtained by laminating a transflective polarizer of the present invention, a light transmitting plate having a light source placed on the edge and a reflector in this order.

Third, the present invention provides a transflective liquid crystal display obtained by placing a polarizing light source device of the present invention, a liquid crystal cell and a dichroic polarizer in this order. In this case, one or more phase retarders may also be placed between the transflective polarizer and the liquid crystal cell and/or between the liquid crystal cell and the dichroic polarizer. Further, a light diffusive layer may be placed between the liquid crystal cell and the dichroic polarizer.

### BRIEF EXPLANATION OF THE INVENTION

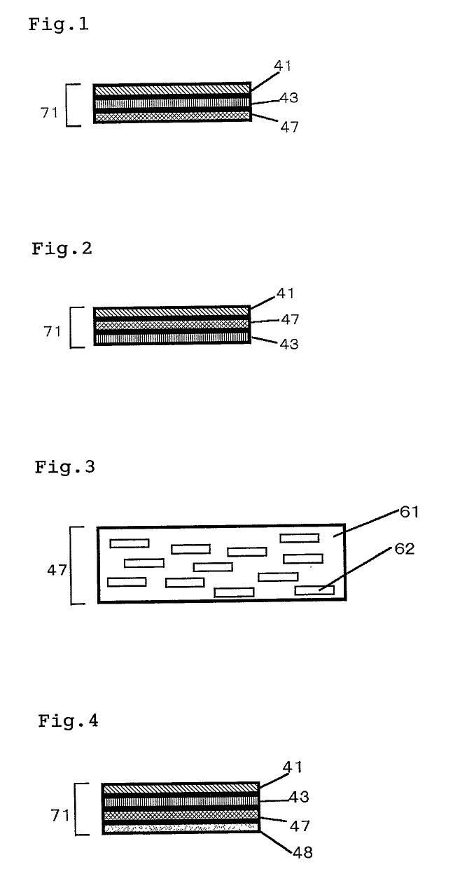

FIG. 1 is a schematic sectional view showing a example of a transflective polarizer of the present invention.

FIG. 2 is a schematic sectional view showing another example of a transflective polarizer of the present invention.

FIG. 3 is a schematic sectional view showing scaly reflective particles oriented in a resin film.

FIG. 4 is a schematic sectional view showing another example of a transflective polarizer of the present invention.

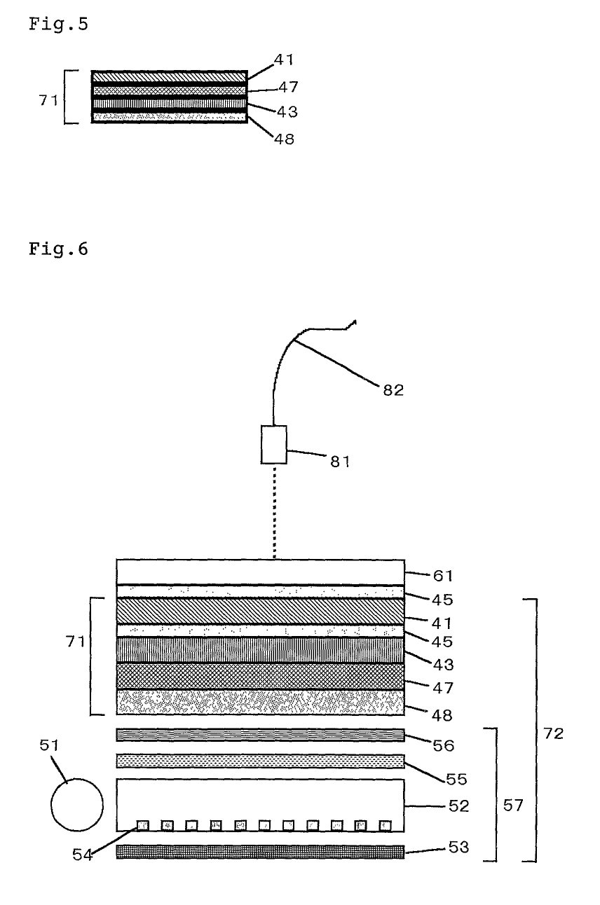

FIG. 5 is a schematic sectional view showing another example of a transflective polarizer of the present invention.

FIG. 6 is a schematic sectional view showing a constitution of a transmission brilliance evaluation apparatus in examples.

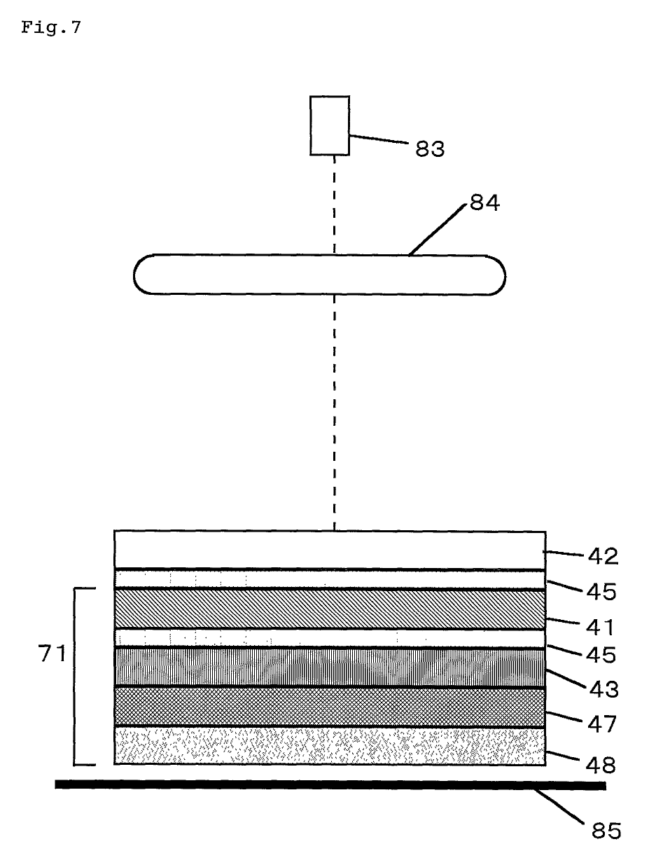

FIG. 7 is a schematic sectional view showing a constitution of a reflection brilliance evaluation apparatus in examples.

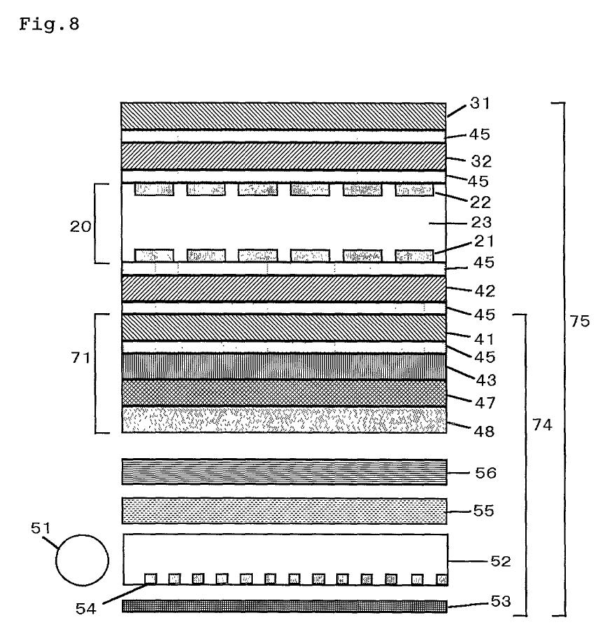

FIG. 8 is a schematic sectional view showing a example of a transflective liquid crystal display device of the present invention.

FIG. 9 is a schematic sectional view showing a example of a transflective liquid crystal display device of the conventional technology.

### DETAILED DESCRIPTION OF THE PREFERRED EMBODIMENTS

The present invention will be illustrated below in detail using drawings.

As shown in FIG. 1 and 2, a transflective polarizer (71) of the present invention is obtained by laminating a dichroic polarizer (41), a reflective polarizer (43) and a transflector (47) wherein a transmission axis of the dichroic polarizer (41) and a transmission axis of the reflective polarizer (43) are directed to the same direction. Here, the transmission axis of the dichroic polarizer and the transmission axis of the reflective polarizer are directed to the direction at which the transmittance is maximum when polarized light having vibration in a specific direction comes along the vertical direction to the polarizer.

The reason why the transmission axis of the dichroic polarizer and the transmission axis of the reflective polarizer are directed to the same direction is that polarized light passed the reflective polarizer can also pass the dichroic polarizer effectively. Therefore, it is most preferable that the transmission axes of these two polarizers are directed completely to the same direction, however, if light loss due to mutual crossing of the transmission axes can be ignored, such direction can be substantially regarded as the same direction. Specifically, when the crossing angle is about 10° or less, no problem occur in use.

In the present invention, the order of lamination of a dichroic polarizer, a reflective polarizer and a transflector is desirably the order of the dichroic polarizer (41), the reflective polarizer (43) and the transflector (47) (FIG. 1), or the order of the dichroic polarizer (41), the transflector (47) and the reflective polarizer (43) (FIG. 2). Further, when the in-plane phase retardation value of the transflector is large or the direction of the slow axis of the transf lector is not constant, the order of the dichroic polarizer, reflective polarizer and transflector is more preferable, and when the in-plane phase retardation value of the reflective polarizer is large, the order of the dichroic polarizer, transflector and reflective polarizer is more preferable. Moreover, the same or different two or more transflectors may be used, and a laminate in the order of the dichroic polarizer, transflector, reflective polarizer and transflector may also be used.

The dichroic polarizer in the present invention serves to transmit a polarized light having vibration in a specific direction and to absorb a polarized light orthogonal thereto. As such dichroic polarizer, well-known iodine-based polarizing films and dye-based polarizing films, for example, can be used. The iodine-based polarizing film is obtained by allowing iodine to be adsorbed into an extended polyvinyl alcohol film, and the dye-based polarizing film is obtained by allowing a dichroic dye to be adsorbed into an extended polyvinyl alcohol film. It is preferred that these polarizing films have one side thereof or both sides thereof coated with (a) polymer film(s) in order to protect the polarizing films and enhance their durability. As the polymer used for this protective coating, cellulose diacetate, cellulose triacetate, polyethylene terephthalate, norbornene resin and the like can be used. Further, as the polymer film used for this protective coating, reflective polarizers and transflectors described below can be used. A thickness of the dichroic polarizer is not particularly restricted. When the transflective polarizer of the present invention is used in a liquid crystal display or the like, it is preferred that the polarizer is thin and the thickness thereof is preferably about 1 mm or less, more preferably about 0.2 mm or less.

The reflective polarizer in the present invention serves to transmit polarized light having vibration in a specific direction and to reflect polarized light having vibration orthogonal thereto. As this reflective polarizer, there can be used reflective polarizers utilizing a difference in reflectance of polarizing components due to an angle of polarization (for example, Published Japanese Translation of PCT International Application (PCT-JP) No. Hei 6-508449-A), reflective polarizers utilizing a selective reflection characteristic by a cholesteric liquid crystal (for example, Japanese Laid-Open Patent Publication (JP) No. Hei 3-45906-A), reflective polarizers on which fine metal linear patterns have been formed (for example, JP No. Hei 2-308106-A), reflective polarizers comprising two kinds of polymer films to utilize a reflectance anisotropy due to a refractive index anisotropy (for example, PCT-JP No. Hei 9-506837-A), reflective polarizers consisting of continuous polymer matrix with droplets dispersed therein to utilize a reflectance anisotropy due to a refractive index anisotropy (for example, U.S. Pat. No. 5,825,543), reflective polarizers having particles distributed in a polymer film to utilize a reflectance anisotropy due to a reflectance index anisotropy (for example, PCT-JP No. Hei 11-509014-A), reflective polarizers having inorganic particles dispersed in a polymer film to utilize a reflectance anisotropy due to a difference in scattering property depending on a size of the particles (for example, JP No. Hei 9-297204-A), and the like.

A thickness of these reflective polarizers is not particularly restricted. When a transflective polarizer of the present invention is used for a liquid crystal display or the like, it is preferred that the reflective polarizer is thin and the thickness thereof is preferably about 1 mm or less, more preferably about 0.2 mm or less.

In order to reduce the thickness of transflective polarizers of the present invention, it is preferred to utilize a reflective polarizers utilizing a selective reflection characteristic by a cholesteric liquid crystal, reflective polarizers comprising two kinds of polymer films to utilize a reflectance anisotropy due to a refractive index anisotropy, reflective polarizers consisting of continuous polymer matrix with droplets dispersed therein to utilize a reflectance anisotropy due to a refractive index anisotropy. However, since a transflective polarizer of the present invention functions against liner polarized light, when the reflective polarizer utilizing a selective reflection characteristic by a cholesteric liquid crystal is used, it is necessary that an optical element, which converts circular polarized light into linear polarized light, is laminated to give a reflective polarizer. This optical element is generally called a quarter wavelength plate.

For obtaining a transflective liquid crystal display having a bright display screen, it is preferable that the light absorptance of a transflective polarizer of the present invention is low. For this purpose, it is preferable that the transmittance of a dichroic polarizer used in a transflective polarizer of the present invention is high. In general, when the transmittance of a dichroic polarizer increases, the degree of polarization decreases, consequently leading to reduction in contrast of an image when used in a liquid crystal display, while in a transflective polarizer of the present invention, a dichroic polarizer and a reflective polarizer are used together, resultantly, when the degree of polarization of the reflective polarizer is high, the transmittance of the dichroic polarizer can be increased and the degree of polarization can be decreased within given ranges.

A transflector of the present invention is a layer in which a part of incident light transmits and a remaining part reflects. Sinceapart,whichisnottransmittedandreflected in all incident light, is absorbed by a transflector and can not be used effectively, it is preferable that this absorption is as low as possible. As this transflector, layers obtained by dispersing particles or voids having different refractive indices from the resin composed of a resin film into a transparent or translucent resin film, layers obtained by forming a hardened film of a light or heat-setting resin comprising dispersed particles or voids having different refractive indices on a transparent or translucent resin film, layers obtained byproviding ametal thin layer on a transparent or translucent resin film, layers comprising a multi-layer laminate composed of two or more polymer films and the like, can be used alone or in lamination of two or more of these layers. When two or more layers are laminated, the same layers may be used, or different layers may be used.

The material of the resin film used in a transflector of the present invention is not particularly restricted, and there can be used synthetic polymers and natural polymers. Examples of synthetic polymers include polyolefin-based resins such as polyethylene, polypropylene and the like, polyvinyl chloride-based resins, vinyl acetate-based resins, polyester-based resins such as polyethylene terephthalate, polyethylene naphthalate and the like, cyclic polyolefin-based resins such as norbornene and the like, polycarbonate-based resins, polysulfone-based resins, polyethersulfone-based resins, polyarylate-based resins, polyvinyl alchol-based resins, polyurethane-based resins, polyacrylate-based resins, polymethacrylate-based resins and the like. Examples of natural polymers include cellulose-based resins such as cellulose diacetate, cellulose triacetate and the like. Further, these resin material may also be a pressure sensitive adhesive. In this case, acrylate-based pressure sensitive adhesives, methacrylate-based pressure sensitive adhesives, vinyl chloride-based pressure sensitive adhesives, synthetic rubber-based pressure sensitive adhesives, natural rubber-based pressure sensitive adhesives, silicone-based pressure sensitive adhesives and the like can be used. Among these pressure sensitive adhesives, the acrylate-based pressure sensitive adhesive is one of preferable adhesives from the standpoints of handling property and durability. As the light or heat-setting resin, well-known resins can be used. Examples of these resins include compounds having a reactive double bond such as an acrylate group, methacrylate group, aryl group and the like, and compounds having a ring-opening condensation reaction group such as an epoxy group and the like. In conducting light or heat-setting, a photopolymerization initiator, and additives such as a heat stabilizer, ultraviolet stabilizer, leveling agent and the like can be added to the light or heat-setting resin. For conducting the light or heat-setting, well-known methods can be used.

The material of particles having different refractive indices used in a transflector of the present invention is not particularly restricted, any of organic particles and inorganic particles can be used. Examples of organic particles include particles of polymers like polyolef in-based resins such as polystyrene, polyethylene, polypropylene and the like, polymethacrylate-based resins, polyacrylate-based resins and the like, and cross-linked polymers may also be permissible. Further, there can also be used copolymers obtained by copolymerizing two or more compounds selected from the group consisting of ethylene, propylene, styrene, methyl methacrylate, benzoguanamine, formaldehyde, melamine, butadiene and the like. Examples of inorganic particles include particles of silica, silicone, titanium oxide, mica, glass, talk, hydrotalcite, aluminum oxide and the like. The hue of particles is preferably colorless or white, and colored fine particles may also be used for imparting ornamental property. Further, for improving the reflectance of light by particles, a material having high refractive index may also be coated on the surface of particles. In coating, it is preferable to control the coating thickness so that a coated film of the material having high refractive index becomes a film increasing reflection. As the material having high refractive index, metal oxides such as titanium oxide and the like can be suitably used. The form of particles is not particularly restricted, and spherical, spindle-like or amorphous particles can be used, and scaly particles are preferable for effectively imparting reflective ability. As shown in a schematic sectional view of FIG. 3, further, it is preferable that this scaly particle (62) is oriented parallel to the surface of a resin film (61). When the particle size is too small, an ability of light scattering is not manifested, and when too large, an image quality is decreased in use in a liquid crystal display, therefore, it is preferable that the particle size is about 0.1 μm or more and about 100 μm or less. The amount of fine particles added can be appropriately set depending on the amplitude of the desired reflectance. Usually, the amount added is about 0.01 part by weight or more and about 50 parts by weight or less based on 100 parts by weight of a resin.

The metal used in metal film in the present transflector is not particularly restricted, and aluminum, silver and the like can be suitably used. A thickness of the metal film is controlled depending on the desired transmission ability and reflection ability. That is, in order to increase a transmittance of the transflector and decrease a reflectance of the transflector, thethicknessofametalfilmisdecreased. On the other hand, in order to increase a reflectance and decrease a transmittance, the thickness of a metal film is increased. The thickness of a metal film is usually about 1 nm or more and about 100 μm or less. The thickness of about 5 nm or more and about 1 μm or less is preferably used, and the thickness of about lOnm or more and about 100 nm or less is more preferably used. As a method for providing a metal film on a transparent polymer film, a vapor deposition method and sputtering method are suitably used, and a method in which a thin metal film obtained by rolling a metal may also be pasted by an adhesive including a pressure sensitive component. In providing a metal film on a resin film, a known under coat layer may be provided for improving close adherence, or a known over coat layer may be provided for protection of a metal film.

The material of polymer film, which can be used in a transflector of the present invention, is not particularly restricted, and the above-mentioned materials, which can be used in the resin film, can be used likewise. As a method for laminating a plurality of thin polymer films to impart reflective ability, there can be used, for example, a method described by J. A. RADFORD et. al. in POLYMER ENGINEERING AND SCIENCE, p. 216, No. 13 (1973).

In the present invention, it is preferable that the slow axis or fast axis of a transflector and the transmission axis of a dichroic polarizer are directed to the same direction. Alternatively, it is preferable that the in-plane phase retardation value of a transflector is about 30 nm or less. Here, a slow axis or fast axis of a transflector indicates a direction at which the in-plane refractive index of the transflector is maximum, or a direction at which the in-plane refractive index of the transflector is minimum, respectively. The angle formed of these axes and in-plane phase retardation value are so restricted that polarizing condition of polarized light passed through a dichroic polarizer and reflective polarizer is not influenced by the transflector. Therefore, it is most preferable that the direction of the slow axis or fast axis of a transflector coincides strictly with the direction of the transmission axis of a dichroic polarizer, however, even if there is a slight difference between them, they can be substantially regarded as the same direction because an influence exerted on polarizing condition is small. When the difference in the angle formed of these axes is about 10° or less, an influence exerted on polarizing condition is usually small, and use can be made without a problem. The in-plane phase retardation value of a transflector is most preferably about 0 nm, and when it is about 30 nm or less, use can be usually made without a problem. The restrictions of the angle formed of these axes and in-plane phase retardation value are particularly effective when a transflector is placed between a dichroic polarizer and a reflective polarizer.

When the light diffusion property of a transflective polarizer of the present invention is weak, a light diffusive layer can be laminated on at least one surface of a dichroic polarizer. As this light diffusive layer, there can be used layers obtained by dispersing particles having different refractive index from the resin into a transparent or translucent resin film, layers obtained by forming a hardened film of a light or heat-setting resin comprising dispersed particles having different refractive index on a transparent or translucent resin film, and the like.

The resin film and hardened film of a light or heat-setting resin used in a light diffusive layer are not particularly restricted, and known films can be used. For example, there can be used the substances as exemplified for the resin film and hardened film of a light or heat-setting resin which can be used in the above-mentioned transflector.

The material of particles having different refractive indices used in a light diffusive layer in the present invention is not particularly restricted, any of organic particles and inorganic particles can be used. As the organic particle, there are listed, for example, polymer particles of polyolefin-based resins such as polystyrene, polyethylene, polypropylene and the like, acrylic resins and the like, and cross-linked polymer particles may also be permissible. Further, there can also be used copolymer particles obtained by copolymerizing two or more monomers selected from the group consisting of ethylene, propylene, styrene, methyl methacrylate, benzoguanamine, formaldehyde, melamine, butadiene and the like. As the inorganic particle, there are listed particles of silica, silicone, titanium oxide, glass, aluminum oxide and the like. The hue of the light diffusive layer is preferably colorless or white, and colored fine particles may also be used for imparting ornamental property. The form of particles in light diffusive layer is not particularly restricted, and spherical, spindle-like or cube-like particles are be used suitably since it is preferable that the light diffusive layer functions as a forward scattering element. When the particle size is too small, a light diffusion ability is not manifested, and when too large, an image quality is decreased in use in liquid crystal displays, therefore, it is preferable that the particle size is about 0.1 μm or more and about 50 μm or less. The amount of particles added can be appropriately set depending on the amplitude of the desired reflectance. Usually, the amount added is about 0.01 part by weight or more and about 50 parts by weight or less based on 100 parts by weight of a resin.

In laminating a light diffusive layer, it is preferable that the slow axis or fast axis of the light diffusive layer and the transmission axis of a dichroic polarizer are directed to the same direction or the in-plane phase retardation value of the light diffusive layer is about 30 nm or less.

When a transflective polarizer of the present invention is used in a liquid crystal display, unevenness in brilliance reflecting the form of a back light source may occur sometimes. In this case, two transflectors can be used as shown in FIGS. 4 and 5. Here, two same transflectors may be used, or two different transflectors may be used.

In laminating a transflective polarizer of the present invention, it is preferable to laminate closely constituent elements by sandwiching a pressure sensitive adhesive so that an air layer is not generated between constituent elements or layers, to decrease light loss on interface with air. Known pressure sensitive adhesives can be use, and for example, acrylate-based pressure sensitive adhesives, methacrylate-based pressure sensitive adhesives, vinyl chloride-based pressure sensitive adhesives, synthetic rubber-based pressure sensitive adhesives, natural rubber-based pressure sensitive adhesives, silicone-based pressure sensitive adhesives and the like can be used. Among these pressure sensitive adhesives, the acrylate-based pressure sensitive adhesives are particularly preferable from the standpoints of handling property and durability.

In one embodiment of polarizing light source devices in the present invention, a transflective polarizer of the present invention, a light source and reflector are placed in this order, wherein the light source and reflector are placed on a surface opposite to a dichroic polarizer of this transflective polarizer. Here, at least one piece of a diffusion sheet may also be placed between a transflective polarizer and a light source.

In another embodiment of polarizing light source devices in the present invention, a transflective polarizer of the present invention, a light transmitting plate having a light source placed on the edge, and a reflector are placed in this order, wherein the light transmitting plate and reflector are placed on a surface opposite to a dichroic polarizer of this transflective polarizer. Here, at least one piece of a diffusion sheet and/or at least one piece of lens sheet may also be placed between a transflective polarizer and a light transmitting plate.

A light source in the present invention is not particularly restricted, and there can be used those used in known polarizing light source devices and liquid crystal displays. That is, a cold cathode tube, light emitting diode, inorganic or organic EL lamps and the like can be used.

A reflector in the present invention is not particularly restricted, and there can be used those used in known polarizing light source devices and liquid crystal displays. That is, there can be used awhite plastic sheet containing voids formed therein, a plastic sheet on which a white pigment such as titanium oxide, zinc oxide and the like has been painted on the surface, a plastic sheet obtained by laminating two or more plastic films having different refractive indices, a metal sheet of aluminum, silver and the like can be used. As this sheet, any of mirror finished sheets and roughened sheets can be used. The material of this plastic sheet is not particularly restricted, and there can be used polyvinyl chloride, polyethylene terephthalate, polyethylene naphthalate, polycarbonate, norbornene, polyurethane, polyacrylate, polymethyl methacrylate and the like can be used.

A light transmitting plate in the present invention serves to fetch light emitted from the light source into an inner portion thereof and functions as a plate-shaped luminous illuminant, and a well-known light transmitting plate can be used.

The light transmitting plate may comprises a plastic sheet or a glass plate which is subjected to an unevenness process, a white dot printing process, a hologram process or the like on its back surface. A material of the plastic sheet is not particularly restricted, and preferred examples of material of the plastic sheet include polycarbonate, norbornene, polymethyl methacrylate and the like.

The diffusion sheet used in the present invention serves to scatter and transmit incident light, and may be an optical element having a total light transmittance of about 60% or more and a haze value of 10% or more. The higher total light transmittance is preferred. Specifically, the total light transmittance is preferably about 80% or more.

Such a diffusion sheet is not particularly restricted. Examples of the diffusion sheet include a plastic sheet or a glass plate, which is subjected to roughing process or has a cavity in an inner portion thereof or has particles added into an inner portion thereof. A material for the plastic sheet for the diffusion sheet is not particularly restricted. Examples of the material for the plastic sheet include polyethylene, polypropylene, polyvinyl chloride, polyethylene terephthalate, polyethylene naphthalate, polycarbonate, norbornene, polyurethane, polyacrylate, polymethyl methacrylate and the like. A method of the roughening process is not particularly restricted. For example, the roughing process can be carried out in a method in which a sand blasting or an emboss roll is used to press the plastic sheet, or a method in which a surface of a plastic sheet is coated with a resin having plastic particles, glass particles, silicon particles or the like mixed therewith.

The lens sheet used in the present invention serves to collect light emitted from a light source and a well-known lens sheet can be used. Examples of the lens sheet include a plastic sheet having a large number of fine prisms formed thereon and a micron lens array formed with convex lenses or concave lenses.

The transflective liquid crystal display of the present invention comprises, in the following order, a polarizing light source device obtained in accordance with the present invention, a liquid crystal cell and another dichroic polarizer, wherein the liquid crystal cell and another dichroic polarizer are placed on a surface opposite to a reflector used in the polarizing light source device. Here, a phase retarder effecting optical compensation and a light diffusive layer may also be intercalated between the polarizing light source device and the liquid crystal cell and/or between the light crystal cell and the dichroic polarizer, if necessary. Further, these members are preferably adhered closely via a pressure sensitive adhesive.

### EXAMPLE

Practical embodiments of the present invention will be illustrated by the following examples, but the present invention is not limited to these examples.

Evaluation methods are as follows.

(1) Total light transmittance and haze value

A sample obtained by pasting a transflective polarizer on a glass plate via a pressure-sensitive adhesive was placed on Haze Computer HGM-2DP (manufactured by Suga Shikenki K. K.) so that measuring light comes from the glass plate side, and the total light transmittance and haze value were measured.

(2) Luminous correction transmittance

A Nicole Prism was mounted on ameasuring light emitting place of a sample chamber of Shimadzu Automatic Spectrophotometer UV-2200 (manufactured by Shimadzu Corp.) so that polarized light having vibration in a specific direction is emitted. Then, a sample obtained by pasting a glass plate via a pressure sensitive adhesive to the side of a dichroic polarizer of a transflective polarizer was placed on a light route of the polarized light along a direction so that the polarized light comes vertically from the glass plate and the transmittance of the polarized light is maximum, and measurement was conducted at incident wavelengths from 400 nm to 700 nm at an interval of 10 nm, and the transmittance T (TD, λ) at each wavelength λ was obtained. Next, the direction of these polarizers was rotated by 90°, measurement was conducted again at an incident wavelengths from 400 nm to 700 nm at an interval of 10 nm, and the transmittance T (MD, λ) at each wavelength λ along an orthogonal axis to the transmission axis of the polarizsr was obtained. The stimulation value Y in a C-light-source 2° visual field was calculated in accordance with JIS Z8701 using the average value of these transmittances, to give the luminous correction transmittance.

(3) Luminous correction polarizing coefficient

The parallel transmittance T (parallel, λ) at each wavelength λ was calculated according to the formula (1) and the orthogonal transmittance T (orthogonal, λ) at each wavelength λ was calculated according to the formula (2), using transmittances measured above in (2).

T(parallel, λ)=(T(TD, λ)²+T(MD, λ)²)/2 (1)

T(orthogonal, λ)=T(TD, λ)×T(MD, λ) (2)

The stimulation value Y in a C-light-source 2° visual field was calculated in accordance with JIS Z8701 using these transmittances, to give the luminous correction parallel transmittance Y (parallel) and luminous correction orthogonal transmittance Y (orthogonal). The luminous correction polarizing coefficient Py was calculated according to the formula (3) using these resulted values.

Py=((Y(parallel)−((orthogonal))/((Y(parallel)+Y(orthogonal))^{½} (3)

(4) Luminous correction reflectance

An absolute reflectance measuring device was mounted on Shimadzu Automatic Spectrophotometer UV-3100PC (manufactured by Shimadzu Corp.), then, a sample obtained by pasting a transflective polarizer to a glass plate was placed so that the measuring light comes from the glass plate side, and measurements were conducted at incident wavelengths from 380 nm to 780 nm at an interval of 5 nm at two directions of the transflective polarizer along one direction and a orthogonal direction to the above-mentioned direction, for removing influences by polarizing components of the measuring light, and the results were averaged to obtain the reflectance at each wavelength. Next, the stimulation value Y in a C-light-source 2° visual field was calculated using color measuring soft ware appended to the spectrophotometer, to obtain the luminous correction reflectance.

(5) Transmission brilliance

As shown in FIG. 6, a light source device (57) was obtained by placing a reflector (53) made of forming PET (polyethylene terephthalate film) and a diffusion sheet (55) over each side of a light transmitting plate (62) which had a light source (51) comprising a cold cathode tube placed on its edge and white dot print (54) provided on one side thereof. A unit was obtained by placing a transflective polarizer (71) over a glass plate (61) having a thickness of 1.1 mm via a pressure sensitive adhesive so that a dichroic polarizer (41) faced the glass plate (61). Then, a polarizing light source device (72) was obtained by placing the unit above-mentioned over the light source apparatus (57). In a direction vertical to the surface of the obtained polarizing light source device (72), was provided a light measuring part (81) connected with a light receiving part of a spectrophotometer through an optical fiber (82). Bright-line spectra corresponding to “Blue”, “Green” and “Red” of the cold cathode tuber (51) used as a light source for the polarizing light source device (72) had maximum absorbance at 435 nm, 545 nm and 612 nm, respectively. At each of the wavelengths, a light receiving intensity of the polarizing light source device was measured.

(5) Reflection brilliance

An instrument obtained by removing a loupe from Round Loupe ENV-B-2 (manufactured by Otsuka Kogaku K. K.) was used as a cyclic outer light source device. As shown in FIG. 7, a cyclic fluorescent lamp (84) of Round Loupe was placed horizontally at a height of 25 cm from the pedestal. A black paper (85) was placed on the pedestal for absorbing excess light. A thermometer was placed on the black paper in a dark room, and the input power was controlled so that the illumination of the cyclic fluorescent lamp was 1000 lux. Subsequently, a transflective polarizer pasted on a glass plate was placed, instead of the illumination meter, at the center so that the surface of the glass plate was the incident light surface. Then, the reflection brilliance of the sample was measured by using a brilliance meter BM-7 (83) placed on the upper portion thereof.

As the dichroic polarizer, commercially available iodine-based polarizing films, SUMIKALAN®SR1862A, SR1872A and SR1882A (all manufactured by Sumitomo Chemical Co., Ltd.) were used. The luminous correction transmittance and luminous correction polarizing coefficient of these dichroic polarizers are shown in Table 1.

As the reflective polarizer, commercially available film, optical film DBEF (manufactured by Sumitomo 3M Ltd.) was used. The luminous correction transmittance and luminous correction polarizing coefficient are shown in Table 1.

As the transflector, commercially available AS-011, AS-031 (all manufactured by Sumitomo Chemical Co., Ltd.). The AS-011 was obtained by laminating and integrating a transflector composed of a pressure sensitive adhesive containing dispersed pear mica with a transflector composed of a polyethylene terephthalate film containing dispersed a whit pigment. The AS-031 was obtained by laminating and integrating a transflector composed of a pressure sensitive adhesive containing dispersed pear mica with a polyethylene terephthalate film. However, in investigation, a transflector composed of a pressure sensitive adhesive containing dispersed pear mica, a transflector composed of a polyethylene terephthalate film containing dispersed whit pigment and a polyethylene terephthalate film were used separately without laminating and integrating.

As shown in FIG. 8, a polarizing light source device (74) can be produced by placing a commercially available lens sheet (56) (for example, BEF, trade name, manufactured by Sumitomo 3M Corp.) on the back surface of a transflective polarizer (71), placing a commercially available diffusion sheet (55) (for example, Light Up, trade name, manufactured by KIMOTO K. K.) on the back surface, placing a light transmitting plate (52) made of polymethylmethacrylate having a light source (51) composed of a cold cathode tube placed on the edge thereof, and further placing a reflector (53) made of a foamed white polyethylene terephthalate film on the back surface.

A transflective liquid crystal display (75) can be produced by placing a phase retarder (42) (for example, SUMIKALIGHT®, manufactured by Sumitomo Chemical Co., Ltd.), if necessary, on the front surface of the polarizing light source device (74), further placing a liquid crystal cell (20) on the front surface thereof, further placing a front surface phase retarder (32) if necessary, and further placing a front surface dichroic polarizer (31).

### Comparative Example 1

A pressure sensitive adhesive containing dispersed pearl mica (component part of AS-011) as a transflector was closely adhered and laminated on a dichroic polarizer (SUMIKALAN@SR1862A), further, a polyethylene terephthalate film containing dispersed white pigment (component part of AS-011) as a transflector was closely adhered and laminated, to obtain a conventional transflective polarizer. The total light transmittance, haze value and luminous correction reflectance of the transflective polarizer are shown in Table 3.

### Example 1

A reflective polarizer (Optical film DBEF) was closely adhered and laminated via a pressure sensitive adhesive on a dichroic polarizer (SUMIKALAN®SR1862A) so that the transmission axis of the dichroic polarizer and the transmission axis of the reflective polarizer are directed to the same direction. The luminous correction transmittance and the luminous correction polarizing coefficient of this laminated and integrated article are shown in Table 2. Further, a pressure sensitive adhesive containing dispersed pearl mice (component part of AS-011) as a transflector was closely adhered and laminated on the side of the reflective polarizer of the laminated and the integrated article, further, a polyethylene terephthalate film containing white pigment (component part of AS-011) as a transflector was closely adhered and laminated, to obtain a transflective polarizer. The total light transmittance, haze value and luminous correction reflectance of the transflective polarizer are shown in Table 3. The ratio of the transmission light receiving intensity and the ratio of the reflection brilliance of the transflective polarizer to those obtained in Comparative Example 1 are shown in Table 4.

These results teach that the transflective liquid crystal display obtained by using the transflective polarizer shows, when used as a reflective liquid crystal display, approximately the same brightness of a screen as compared with that obtained by using a conventional transflective polarizer, while can provide, when used as a transmissive liquid crystal display, a brighter screen as compared with that obtained by using a conventional transflective polarizer.

### Example 2

The same evaluations as in Example 1 were conducted except that SUMIKALAN®SR1872A was used as a dichroic polarizer. The luminous correction transmittance and luminous correction polarizing coefficient are shown in Table 2, the total light transmittance, haze value and luminous correction reflectance are shown in Table 3. The ratio of the transmission light receiving intensity and the ratio of the reflection brilliance of the transflective polarizer to those obtained in Comparative Example 1 are shown in Table 4.

These results teach that the transflective liquid crystal display obtained by using the transflective polarizer shows, when used as a reflective liquid crystal display, approximately the same brightness of a screen as compared with that obtained by using a conventional transflective polarizer, while can provide, when used as a transmissive liquid crystal display, a brighter screen as compared with that obtained by using a conventional transflective polarizer.

### Example 3

The same evaluations as in Example 1 were conducted except that SUMIKALAN®SR1882A was used as a dichroic polarizer. The luminous correction transmittance and luminous correction polarizing coefficient are shown in Table 2, the total light transmittance, haze value and luminous correction reflectance are shown in Table 3. The ratio of the transmission light receiving intensity and the ratio of the reflection brilliance of the transflective polarizer to those obtained in Comparative Example 1 are shown in Table 4.

These results teach that the transflective liquid crystal display obtained by using the transflective polarizer shows, when used as a reflective liquid crystal display, approximately the same brightness of a screen as compared with that obtained by using a conventional transflective polarizer, while can provide, when used as a transmissive liquid crystal display, a brighter screen as compared with that obtained byusingaconventional transflective polarizer.

### Example 4

A reflective polarizer (Optical film DBEF) was closely adhered and laminated via a pressure sensitive adhesive on a dichroic polarizer (SUMIKALAN®SR1862A) so that the transmission axis of the dichroic polarizer and the transmission axis of the reflective polarizer are directed to the same direction. The luminous correction transmittance and the luminous correction polarizing coefficient of this laminated and integrated article are shown in Table 2. Further, a pressure sensitive adhesive containing dispersed pearl mice (component part of AS-011) as a transflector was closely adhered and laminated on the side of the reflective polarizer of the laminated and the integrated article, further, a polyethylene terephthalate film (component part of AS-031) as a transflector was closely adhered and laminated, to obtain a transflective polarizer. The total light transmittance, haze value and luminous correction reflectance of the transflective polarizer are shown in Table 3. The ratio of the transmission light receiving intensity and the ratio of the reflection brilliance of the transflective polarizer to those obtained in Comparative Example 1 are shown in Table 4.

These results teach that the transflective liquid crystal display obtained by using the transflective polarizer shows, when used as a reflective liquid crystal display, slightly lowered brightness of a screen as compared with that obtained by using a conventional transflective polarizer, however, can provide, when used as a transmissive liquid crystal display, a brighter screen as compared with that obtained by using a conventional transflective polarizer.

### Comparative Example 2

A pressure sensitive adhesive containing dispersed pearl mica (component part of AS-031) as a transflector was closely adhered and laminated on a dichroic polarizer (SUMIKALAN®SR1862A), further, a polyethylene terephthalate film (component part of AS-031) as a transflector was closely adhered and laminated thereon, to obtain a conventional transflective polarizer. The total light transmittance, haze value and luminous correction reflectance of the transflective polarizer are shown in Table 3.

### Example 5

A reflective polarizer (Optical film DBEF) was closely adhered and laminated via a pressure sensitive adhesive on a dichroic polarizer (SUMIKALAN®SR1862A) so that the transmission axis of the dichroic polarizer and the transmission axis of the reflective polarizer are directed to the same direction, further, a pressure sensitive adhesive containing dispersed pearl mice (component part of AS-031) as a transflector was closely adhered and laminated thereon, and further, a polyethylene terephthalate film (component part of AS-031) as a transflector was closely adhered and laminated, to obtain a transflective polarizer. The total light transmittance, haze value and luminous correction reflectance of the transflective polarizer are shown in Table 3. The ratio of the transmission light receiving intensity and the ratio of the reflection brilliance of the transflective polarizer to those obtained in Comparative Example 2 are shown in Table 5.

These results teach that the transflective liquid crystal display obtained by using the transflective polarizer shows, when used as a reflective liquid crystal display, approximately the same brightness of a screen as compared with that obtained by using a conventional transflective polarizer, while can provide, when used as a transmissive liquid crystal display, a brighter screen as compared with that obtained by using a conventional transflective polarizer.

### Example 6

The same evaluations as in Example 4 were conducted except that SUMIKALAN®SR1872A was used as a dichroic polarizer. The total light transmittance, haze value and luminous correction reflectance are shown in Table 3. The ratio of the transmission light receiving intensity and the ratio of the reflection brilliance of the transf lective polarizer to those obtained in Comparative Example 2 are shown in Table 5.

These results teach that the transflective liquid crystal display obtained by using the transflective polarizer shows, when used as a reflective liquid crystal display, approximately the same brightness of a screen as compared with that obtained by using a conventional transflective polarizer, while can provide, when used as a transmissive liquid crystal display, a brighter screen as compared with that obtained by using a conventional transflective polarizer.

### Example 7

The same evaluations as in Example 4 were conducted except that SUMIKALAN®SR1882A was used as the dichroic polarizer. The total light transmittance, haze value and luminous correction reflectance are shown in Table 3. The ratio of the transmission light receiving intensity and the ratio of the reflection brilliance of the transflective polarizer to those obtained in Comparative Example 2 are shown in Table 5.

These results teach that the transflective liquid crystal display obtained by using the transflective polarizer shows, when used as a reflective liquid crystal display, approximately the same brightness of a screen as compared with that obtained by using a conventional transflective polarizer, while can provide, when used as a transmissive liquid crystal display, a brighter screen as compared with that obtainedbyusing aconventional transflective polarizer.

### Example 8

A pressure sensitive adhesive containing dispersed pearl mice (component part of AS-031) as a transflector was closely adhered and laminated on a dichroic polarizer (SUMIKALAN®SR1862A), and further, a reflective polarizer (Optical film DBEF) was closely adhered and laminated so that the transmission axis of the dichroic polarizer and the transmission axis of the reflective polarizer are directed to the same direction. The total light transmittance, haze value and luminous correction reflectance are shown in Table 3. The ratio of the transmission light receiving intensity and the ratio of the reflection brilliance of the transflective polarizer to those obtained in Comparative Example 2 are shown in Table 5.

These results teach that the transflective liquid crystal display obtained by using the transflective polarizer shows, when used as a reflective liquid crystal display, slightly increased brightness of a screen as compared with that obtained by using a conventional transflective polarizer, while can provide, when used as a transmissive liquid crystal display, a brighter screen as compared with that obtained by using a conventional transflective polarizer.

When a transflective polarizer of the present invention is used, a brighter screen is obtained using the same consumption power as a conventional technology though the reflection brilliance is equivalent to that of a conventional technology. Therefore, the consumption powder can be reduced at the same screen brilliance as that of a conventional technology, and use of a liquid crystal display for a long period of time is possible by one action of charging a battery. Alternatively, the volume of a battery can be decreased, enabling a production of a liquid crystal display having a compact size and light.

TABLE 1

| | Luminous correction | Luminous correction |
|---|---|---|
| | transmittance (%) | polarizing coefficient (%) |
| SR1862A | 43.2 | 99.9 |
| SR1872A | 44.1 | 99.5 |
| SR1882A | 45.2 | 96.7 |
| DBEF | 44.8 | 94.7 |

TABLE 2

| | Luminous correction | Luminous correction |
|---|---|---|
| | transmittance (%) | polarizing coefficient (%) |
| Example 1 | 40.9 | 100.0 |
| Example 2 | 41.6 | 100.0 |
| Example 3 | 42.1 | 99.8 |

TABLE 3

| | Total light | Haze value | Luminous correction |
|---|---|---|---|
| | transmittance (%) | (%) | reflectance (%) |
| Comparative | 14.3 | 91.6 | 26.1 |
| example 1 | | | |
| Example 1 | 17.5 | 91.2 | 25.8 |
| Example 2 | 17.8 | 91.3 | 26.9 |
| Example 3 | 18.0 | 91.7 | 27.5 |
| Example 4 | 16.4 | 82.1 | 25.1 |
| Comparative | 24.3 | 63.6 | 19.3 |
| example 2 | | | |
| Example 5 | 26.0 | 66.3 | 19.1 |
| Example 6 | 26.5 | 66.0 | 19.5 |
| Example 7 | 26.7 | 65.7 | 20.0 |
| Example 8 | 23.0 | 64.1 | 19.4 |

TABLE 4

| | Ratio of transmission light | | | Ratio of |
|---|---|---|---|---|
| | receiving intensity | | | reflection |
| | 435 nm | 545 nm | 612 nm | brilliance |
| Example 1 | 1.48 | 1.44 | 1.37 | 0.97 |
| Example 2 | 1.56 | 1.48 | 1.40 | 1.00 |
| Example 3 | 1.64 | 1.51 | 1.44 | 1.07 |
| Example 4 | 1.64 | 1.57 | 1.49 | 0.91 |

TABLE 5

| | Ratio of transmission light | | | Ratio of |
|---|---|---|---|---|
| | receiving intensity | | | reflection |
| | 435 nm | 545 nm | 612 nm | brilliance |
| Example 5 | 1.31 | 1.30 | 1.26 | 1.04 |
| Example 6 | 1.37 | 1.32 | 1.30 | 0.99 |
| Example 7 | 1.42 | 1.36 | 1.32 | 1.02 |
| Example 8 | 1.11 | 1.19 | 1.20 | 1.08 |

What is claimed is:

1. A transflective polarizer comprising a dichroic polarizer, a reflective polarizer and a transflector, wherein a transmission axis of the dichroic polarizer and a transmission axis of the reflective polarizer are directed to the same direction.

2. The transflective polarizer according to claim 1, wherein the dichroic polarizer is an iodine-based polarizing film or a dye-based polarizing film.

3. The transflective polarizer according to claim 1, wherein a light diffusive layer is laminated on at least one surface of the dichroic polarizer.

4. The transflective polarizer according to claim 1, wherein the reflective polarizer is a multi-layer laminate composed of two or more kinds of polymer films.

5. The transflective polarizer according to claim 1, wherein the reflective polarizer is a polymer film consisting of continuous polymer matrix with droplets dispersed therein which is made of two or more kinds of polymers.

6. The transflective polarizer according to claim 1, wherein the reflective polarizer is a polarizer comprising a film having a cholesteric liquid crystal and a quarter wavelength film.

7. The transflective polarizer according to claim 1, wherein a slow axis or fast axis of the transflector and a transmission axis of the dichroic polarizer are directed to the same direction.

8. The transflective polarizer according to claim 1, wherein an in-plane phase retardation value of the transflector is about 30 nm or less.

9. The transflective polarizer according to claim 1, wherein the transflector is a layer obtained by forming a metal film on the surface of a polymer film.

10. The transflective polarizer according to claim 1, wherein the transflector is a layer obtained by dispersing scaly reflective particles into apressure sensitive adhesive.

11. The transflective polarizer according to claim 10, wherein the scaly reflective particle is a particle obtained by forming a layer composed of a metal oxide on the surface of a mica piece.

12. A polarizing light source device obtained by laminating the transflective polarizer according to claim 1, a light source and a reflector in this order.

13. A polarizing light source device obtained by laminating the transflective polarizer according to claim 1, a light transmitting plate having a light source placed on the edge and a reflector in this order.

14. A transflective liquid crystal display obtained by placing the polarizing light source device according to claim 12 or 13, a liquid crystal cell and a dichroic polarizer in this order.

15. The transflective liquid crystal display according to claim 14, wherein one or more phase retarders are placed between the transflective polarizer and the liquid crystal cell and/or between the liquid crystal cell and the dichroic polarizer.

16. The transflective liquid crystal display according to claim 14 or 15, wherein a light diffusive layer is placed between the liquid crystal cell and the dichroic polarizer.
